(19) United States
(12) Patent Application Publication
(10) Pub. No.: US 2014/0259690 A1
(43) Pub. Date: Sep. 18, 2014

(54) MOVEABLE LUBRICATION ASSEMBLY FOR POWER OPERATED ROTARY KNIFE

(71) Applicant: Bettcher Industries, Inc, Birmingham, OH (US)

(72) Inventors: NICHOLAS A. MASCARI, Wellington, OH (US); Kenneth E. Carper, Cincinnati, OH (US)

(73) Assignee: Bettcher Industries, Inc, Birmingham, OH (US)

(21) Appl. No.: 14/205,662

(22) Filed: Mar. 12, 2014

Related U.S. Application Data
(60) Provisional application No. 61/784,545, filed on Mar. 14, 2013.

(51) Int. Cl. B26B 25/00; B26D 7/08

(52) U.S. Cl. CPC B26B 25/002; B26D 7/088
USPC 30/276; 137/1

(57) ABSTRACT

A power operated rotary knife (100) and method of operation includes an annular rotary blade (380). The knife further comprises a head assembly (300) extending from a handle assembly (200), the head assembly for rotatably supporting the annular rotary blade. The knife also includes a drive mechanism (600) disposed within the head assembly comprising a pinion gear (604) and a pinion shaft (970) rotatably disposed within a bushing (610), the drive mechanism being operatively coupled to the annular rotary blade, rotating the annular blade during use. A movable lubrication assembly (900) supported along a frame body between the handle assembly and the annular rotary blade, the rotatable lubrication assembly being rotatably disposed about a longitudinal axis of the handle assembly and providing a lubrication path (1000) extending from a lubrication adapter (924) to the pinion gear (604).

### CROSS REFERENCE TO RELATED APPLICATION

The present application is a non-provisional application that claims priority to U.S. Provisional Application Ser. No. 61/784,545 under 35 U.S.C. §119(e) entitled MOVEABLE LUBRICATION ASSEMBLY FOR POWER OPERATED ROTARY KNIFE, which was filed on Mar. 14, 2013 with the United States Patent Office. The present application claims priority to said provisional application, which is incorporated by reference in its entirety herein for all purposes.

### TECHNICAL FIELD

The present disclosure relates to a moveable lubrication assembly for a power operated rotary knife, and more specifically, a moveable lubrication assembly that includes rotatably positioned lubrication cup arrangement.

### BACKGROUND

Power operated rotary knives are widely used in meat processing facilities for meat cutting and trimming operations. Power operated rotary knives also have application in a variety of other industries where cutting and/or trimming operations need to be performed quickly and with less effort than would be the case if traditional manual cutting or trimming tools were used, e.g., long knives, scissors, nippers, etc. By way of example, power operated rotary knives may be effectively utilized for such diverse tasks as taxidermy; cutting and trimming of elastomeric or urethane foam for a variety of applications, including vehicle seats; and tissue removal or debriding in connection with medical/surgical procedures and/or tissue recovery from a body of a human or animal donor.

Power operated rotary knives typically include a head assembly and a handle assembly. The handle assembly includes an elongated central core and a hand piece mounted on the elongated central core. The hand piece includes a gripping surface to be grasped by an operator or user to manipulate the power operated rotary knife. The elongated central core includes a distal end attachment structure for releasably securing the handle assembly to the head assembly.

The head assembly includes a rotary knife blade, a blade housing for rotatably supporting the rotary knife blade and a frame body. At a proximal end, the frame body includes a mating attachment structure that receives the distal end attachment structure of the handle assembly to releasably secure the handle and head assemblies. At a distal end, the frame body includes a mounting pedestal for detachably mounting the blade housing. The frame body also defines a cavity to support a gear train for rotatably driving the rotary knife blade. The frame member supports the hand grip which is grasped by an operator and used to manipulate the power operated rotary knife.

Further discussion of power operated rotary knives is found in U.S. Pat. No. 5,230,154 to Decker et al. and U.S. Pat. No. 5,400,511 to Decker, both assigned to the assignee of the present application. Both U.S. Pat. No. 5,230,154 to Decker et al. and U.S. Pat. No. 5,400,511 to Decker are incorporated herein in their respective entireties by reference.

### SUMMARY

In one aspect, the present disclosure relates to a power operated rotary knife and method of operation having an annular rotary blade. The knife further comprises a head assembly extending from a handle assembly, the head assembly for rotatably supporting the annular rotary blade. The knife also includes a drive mechanism disposed within the head assembly comprising a pinion gear and a pinion shaft rotatably disposed within a bushing, the drive mechanism being operatively coupled to the annular rotary blade, rotating the annular blade during use. A movable lubrication assembly is supported along a frame body between the handle assembly and the annular rotary blade, the rotatable lubrication assembly is rotatably disposed about a longitudinal axis of the handle assembly and providing a lubrication path extending from a lubrication adapter to the pinion gear.

In another aspect, the present disclosure relates to a method of providing lubrication to a power operated rotary knife comprising the steps of extending a head assembly from a handle assembly, the head assembly for rotatably supporting an annular rotary blade. The method further comprises the step of rotating the annular rotary blade with a drive mechanism comprising a pinion gear and pinion shaft; and lubricating the drive mechanism by providing a moveable lubrication assembly supported along a frame body between the handle assembly and the annular rotary blade.

In yet another aspect, the present disclosure relates to a power operated rotary knife comprising a head assembly extending from a handle assembly, the head assembly for rotatably supporting an annular rotary blade, a drive mechanism being operatively engaged to the annular rotary blade, and a moveable lubrication assembly freely rotatable about the handle assembly and the head assembly, the moveable lubrication assembly providing as needed during use lubrication to the drive mechanism independent of location.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is a schematic top front perspective view of a power operated rotary knife;

FIG. 2 is a schematic rear elevation view of the power operated rotary knife of FIG. 1;

FIG. 3 is a schematic top plan view of the power operated rotary knife of FIG. 1;

FIG. 4 is a schematic bottom plan view of the power operated rotary knife of FIG. 1;

FIG. 5 is a schematic side elevation view of the power operated rotary knife of FIG. 1 as seen from a plane indicated by the line 5-5 in FIG. 3;

FIG. 6 is a schematic longitudinal section view of the power operated rotary knife of FIG. 1 as seen from a plane indicated by the line 6-6 in FIG. 3;

FIG. 7 is a schematic exploded front perspective view of the power operated rotary knife of FIG. 1;

FIG. 8 is a schematic exploded rear perspective view of the power operated rotary knife of FIG. 1;

FIG. 9A is a schematic exploded perspective view of a moveable lubrication assembly for the power operated rotary knife of FIG. 1 constructed in accordance with one example embodiment of the present disclosure;

FIG. 9B is a schematic exploded view of a portion of a gear train and lubrication flow paths in accordance with one example embodiment of the present disclosure;

FIG. 10 is a schematic transverse sectional-view of FIG. 3 along section lines 10-10;

FIG. 11 is a schematic perspective transverse sectional-view of FIG. 3 along section lines 11-11;

FIG. 12 is a schematic partial perspective sectional-view of FIG. 3 along a portion of the longitudinal axis LA of the head and moveable lubrication assemblies, as shown by section lines 12-12;

FIG. 13 is a schematic lower perspective view of a lubrication cup arrangement constructed in accordance with one example embodiment of the present disclosure;

FIG. 14 is a schematic elevation view of the lubrication cup arrangement of FIG. 13;

FIG. 15 is a schematic upper perspective view of a lubrication cup arrangement of FIG. 13;

FIG. 16 is a schematic sectional view of the lubrication cup arrangement of FIG. 15 along section lines 16-16;

FIG. 17 is a schematic top plan view of the power operated rotary knife of FIG. 1 wherein the moveable lubrication assembly and thumb support are positioned on the head assembly at a rotational position suitable for a left-handed operator of the power operated rotary knife;

FIG. 18 is a schematic top plan perspective view of the power operated rotary knife of FIG. 1, the moveable lubrication assembly and pivoting thumb support are positioned on the head assembly at an upright rotational position suitable for a right-handed operator of the power operated rotary knife; and

FIG. 19 is a is a schematic top plan view of the power operated rotary knife of FIG. 1, the moveable lubrication assembly and pivoting thumb support are positioned on the head assembly at an upright rotational position suitable for a left-handed operator of the power operated rotary knife.

### DETAILED DESCRIPTION

Referring now to the figures generally wherein like numbered features shown therein refer to like elements having similar characteristics and operational properties throughout unless otherwise noted. The present disclosure relates to a moveable lubrication assembly for a power operated rotary knife, and more specifically, a moveable lubrication assembly that includes rotatably disposed lubrication cup arrangement.

The power operated rotary knife's moveable lubrication assembly that includes a rotatably disposed lubrication cup arrangement are advantageously rotated with respect to a stationary handle position to provide a plurality of hand/operator orientations, including orientations suitable for left-handed and right-handed use of the power operated rotary knife, without the need for disassembly of the power operated rotary knife. In the illustrated example embodiment that includes a thumb support, the lubrication assembly is capable of endless rotation upon retraction of the thumb support.

Referring now to the drawings, FIGS. 1-8 and 17-19 schematically illustrate an exemplary embodiment of a power operated rotary knife 100 of the present disclosure. The power operated rotary knife 100 includes a handle assembly 200 and a head assembly 300 releasably affixed to the handle assembly. The power operated rotary knife 100 includes a moveable lubrication assembly 900 (best seen in FIGS. 9-16) of the present disclosure rotatably disposed on a portion the head assembly 300.

The moveable lubrication assembly 900 comprises lubrication cup arrangement 500 and seals 506. The lubrication cup arrangement includes a lubrication cup 502 and an annular support 504. In one example embodiment, the lubrication assembly 900 receives a lubricant, such as a food-grade grease (approved by the FDA), but is also capable of receiving other types of lubrication without departing from the spirit and scope of the present disclosure. Other types of suitable lubrication in addition to food-grade grease include, but are not limited to, bearing grease, water-based greases, silicon-based lubricants, water-soluble greases, oils, and the like.

Head Assembly 300

As can best be seen in FIGS. 1, 3, 7 and 8, the head assembly 300 includes a frame housing or frame body 310, a clamping assembly 330, a blade housing 390 and a rotary knife blade 380. The rotary knife blade 380 is supported for rotation about an axis of rotation R (FIGS. 2, 5 and 6) by the blade housing 390. The blade housing 390 defines a rotational plane RP (FIGS. 5 and 6) of the rotary knife blade 380. The blade housing 390, in turn, is releasably affixed to the frame body 310 by a clamp 332 of the clamp assembly 330.

As is best seen in FIGS. 6-8, the frame body 310 also supports a drive mechanism 600 of the power operated rotary knife 100. In one exemplary embodiment, the frame body 310 includes a longitudinally extending, central throughbore 312, which supports a gear train 602 of the drive mechanism 600. Specifically, the gear train 602 includes a pinion gear 604 and an input shaft 970 of the pinion gear 604 is supported for rotation within a cylindrical bushing 610 positioned within a front portion 314 of the throughbore 312. The pinion gear 604 is precisely positioned and oriented by the frame body 310 such that a gear head 606 of the pinion gear meshes with a set of gear teeth 382 of the rotary knife blade 380 to rotate the knife blade 380 within the blade housing 390.

Frame Body 310

The frame body 310 includes a forward or distal blade housing support region 320 and a rearward annular boss 350. The forward blade support region 320 includes a pair of outwardly extending arcuate arms 322 which define a blade housing mounting region 324 for receiving an arcuate mounting section 392 of the blade housing 390 and a clamping receiving region 326 for receiving the proximal wall of the clamp 332 of the clamping assembly 330. The clamp 332 is secured to the frame body 310 by a pair a threaded fasteners 334 that extend through respective openings in the arcuate arms 322 of the frame body 310. The arcuate mounting section 392 of the blade housing 390 is sandwiched between the forward blade housing support region 320 and the clamp 332 to releasably secure the blade housing 390 to the frame body 310. The clamp assembly 330 further includes a steeling assembly 340 which may be depressed by the operator during operation of the power operated rotary knife 100 for steeling the rotary knife blade 380.

In one exemplary embodiment, the rearward annular boss 350 of the frame body 310 includes an inner surface 362 defining a rear portion 316 of the central throughbore 312. The rear portion 316 of the central throughbore includes a threaded section 318. A frame tube (not shown) threads into and is permanently affixed to the threaded section 318 of the rearward annular boss 350. The frame tube (not shown) extends rearwardly though a central throughbore 222 of a hand piece 210 of the handle assembly 300 and includes a threaded proximal end section.

Handle Assembly 300

As can best be seen in FIGS. 1 and 3-6, the handle assembly 200 extends along a longitudinal axis LA. The handle assembly 200 includes a hand piece 210 defining an exterior gripping surface 212 adapted to be gripped by an operator of the power operated knife 100 when wielding and manipulating the knife 100. The hand piece 210 includes a central throughbore 222 (FIG. 6) defined by an inner surface 224 of the hand piece 210. The throughbore 222 is coaxial with the longitudinal axis LA and is aligned with the frame body throughbore 312.

The handle assembly 200 further includes a drive shaft latching assembly 280. The shaft drive latching assembly 280 releasably secures a flexible shaft drive assembly (not shown) of the drive mechanism 600 to the handle assembly 200 such that motive power may be applied to rotate the pinion gear 604 within the throughbore 312 of the frame body 310 and thereby rotate the rotary knife blade 380. The shaft drive latching assembly 280 includes a latching knob 282 secured to a proximal end 220 of the hand piece 210 and a latching member 284 for releasably securing a coupling of the shaft drive assembly to the handle assembly 200.

The latching knob 282 of the drive shaft latching assembly 280 threads onto the threaded end section (not shown) of the frame tube (not shown) of the frame body 310. When the latching knob 282 is threaded onto the threaded proximal end section of the frame tube, the hand piece 210 is thereby sandwiched and secured to the rearward annular boss 350 of the frame body 310.

Rotary Knife Blade 380 and Blade Housing 390

The rotary knife blade 380 of the power operated rotary knife 100 includes the set gear teeth 382 at one axial end of the blade 380 and a blade section 384 at an opposite axial end of the blade 380. The blade section terminates at a lower end at a cutting edge 384. The blade housing 390 includes an annular blade support section 394 that support the rotary knife blade 380 for rotation about the central axis of rotation R and defines the rotational plane RP of the blade, which is substantially orthogonal to the axis of rotation R.

Drive Mechanism 600

The drive mechanism 600 of the power operated rotary knife 100 includes a gear train 602 supported within the central throughbore 312 of the frame body 310. In one exemplary embodiment, the gear train 602 includes the pinion gear 604. The input shaft 970 of the pinion gear 604 is supported for rotation by the cylindrical bushing 610 positioned within the front portion 314 of the throughbore 312, as further illustrated in FIG. 9B. A drive coupling of a flexible shaft drive transmission (not shown) extends through the throughbore 222 of the hand piece 210 of the handle assembly and engages a female coupling 609 (FIG. 2) defined by the pinion gear input shaft 970 to rotate the pinion gear 604. The gear head 606 of the pinion gear 604 operatively engages the set of gear teeth 382 of the rotary knife blade 380 to rotate the knife blade 380 within the blade housing 390.

Thumb Support 400

The thumb support or thumb piece 400 includes the base portion 410 and the thumb supporting portion 450. The base portion 410 includes the annular ring 412 and an upper interface portion 420. An inner surface 414 of the annular ring 412 includes a cylindrical throughbore 416 that defines a central longitudinal axis CLA of the thumb support 400. The annular ring 412 is sized to be snugly received on the middle region 354 of the rearward annular boss 350 of the frame body 310 when the handle assembly 200 is secured to the head assembly 300. When the thumb support 400 is mounted on the rearward annular boss 350, the central longitudinal axis CLA of the thumb support cylindrical throughbore 416 is substantially coincident with the handle assembly longitudinal axis LA.

A distal portion 415 of the inner surface 414 of the annular ring 412 includes a plurality of raised splines 418. The raised splines 418 of the annular ring 412 selectively interfit with mating raised splines 358 of the middle region 354 of the rearward annular boss 350 such that a rotational position of the thumb support 400 on the rearward annular boss 350 of the frame body 310 may be changed as desired. This can be seen by comparing, for example, FIGS. 3 and 13.

In FIG. 1, as viewed from above the power operated rotary knife 100, the thumb support 400 is positioned rotationally on the rearward annular boss 350 to the left of the handle assembly longitudinal axis LA. This position of the thumb supporting surface 454 would be suitable for right-handed use of the power operated rotary knife 100. By contrast, in FIG. 13, as viewed from above, the power operated rotary knife 100, the thumb support 400 is positioned rotationally on the rearward annular boss 350 to the right of the handle assembly longitudinal axis LA. This position of the thumb supporting surface 454 would be suitable for left-handed use of the power operated rotary knife 100. Further discussion relating to the thumb support 400 can be found in U.S. patent application Ser. No. 13/792,424 that was filed on Mar. 11, 2013 and entitled MOVEABLE THUMB SUPPORT ASSEMBLY FOR A POWER OPERATED ROTARY KNIFE assigned to the assignee of the present disclosure under attorney docket number BET-021885 US PRI. The MOVEABLE THUMB SUPPORT ASSEMBLY FOR A POWER OPERATED ROTARY KNIFE U.S. patent application is incorporated herein by reference in its entirety for all purposes.

Movable Lubrication Assembly 900

The moveable lubrication assembly 900, including rotatably disposed lubrication cup arrangement 500 is advantageously rotatable with respect to a stationary handle 200 position, providing a plurality of hand/operator orientations, including orientations suitable for left-handed and right-handed use of the power operated rotary knife 100, without the need for disassembly. Referring specifically to FIGS. 9-16, the design and interconnection of the moveable lubrication assembly 900 are further discussed.

The lubrication cup arrangement 500 includes the lubrication cup 502 coupled to the annular support 504 by way of spout shaft 910 that extends from a bottom 911 of the cup 502 into receiving shaft 912 projecting from the annular support. In the illustrated example embodiment of FIGS. 10, 11, and 16, the receiving shaft 912 includes a number of stepped annular orifices. The first annular orifice 914 receives a front portion 916 of the spout shaft 910, forming a thread connection (not shown) therein. Second 918 and third 920 annular orifices are concentric with the first annular orifice 914, radially located about a first lubrication axis, FLA. The first, second, and third orifices form a through opening 922 that extends into the annular support 504.

The lubrication cup 502 comprises a lubrication adapter or zerk 924 having a through passage P for receiving lubrication into a chamber 926 formed inside the cup. The chamber 926 stores or holds lubrication until selectively advanced to the gear train 602 through lubrication path 1000. The chamber 926 is defined at a lower end 932 by a housing 928 that extends and includes the spout shaft 910. In the illustrated example embodiment, the housing 928 is made from metal but could be other materials such as plastic without departing from the spirit and scope of the disclosure. The chamber 932 is defined at an upper end 934 by an annular bulb 930, which includes an annular arm 936 retained within an annular recess 938 formed in an internal cavity 940 of the housing 928.

In the illustrated example embodiment, the annular bulb 930 is formed from a low durometer plastic or soft rubber, pliable enough for the operator of the rotary knife 100 to elastically advance (without permanent deformation) the bulb inward in the direction of the arrow F, selectively advancing lubrication toward the drive train 602. Providing support and protecting the peripheral wall 941 of the bulb 930 is a circular cap 942. The circular cap 942 includes first and second diameters, 944 and 946, respectively, such that the second diameter 946 is greater than the first diameter. The housing 928 includes a threaded connection beginning at an annular ridge 948 for retaining the cap 942, engaging the first threaded diameter 944 and continuing along the threaded body 946, thus preventing removal of the cap from the cavity 940 without loosening the threaded connection, as illustrated in FIGS. 10 and 16.

Axially aligned with first, second, and third orifices, 914, 918, and 920 are first and second annular passages 950, 952, respectively that extend from the chamber through the spout shaft 910 and orifices, and into the through opening 922 of the annular support 504. The first and second annular passages 950, 952 and orifices, 914, 918, and 920 form a first portion 1002 of the lubrication path 1000.

The annular support 504 includes a circular through chamber 954 having first and second ends, 956, 958, respectively, as best seen in FIG. 13. Located within the chamber 954 are first and second annular grooves 960, 962, surrounding centrally disposed lubrication circular passage channel 964 that forms one-half of an annular lubrication track 975. The third annular orifice 920 passes and forms a lubrication opening 966 in the circular passage channel 964.

During assembly, the circular through chamber 954 is disposed over the rearward annular boss 350 until the second end 958 engages planer wall 968 such that first and second exterior grooves 902, 904 of the boss align with first and second grooves 960, 962 within the chamber to support respective seals 906, 908 and a central lubrication path 963, forming the other half of the annular lubrication track 975 when aligned with the circular lubrication passage channel 964. A base portion 410 of the thumb support 450 secures the moveable location assembly 900 to the rotary knife 100, between the thumb support and planer wall 968. The thumb support 405 is secured to the head assembly 300 via slip rings, splines, screws, or any combination thereof and as further discussed in the U.S. patent application Ser. No. 13/792,424, which is incorporated herein by reference in its entirety.

In one example embodiment, the seals 906 and 908 are a-rings. In another example embodiment, the seals 906, 908 are nitrile gasket material. The seals 906 and 908 contain all lubrication within the annular lubrication track 975 formed by the lubrication circular passage channel 964 and central lubrication channel 963, prohibiting any lubrication from moving in either direction along the longitudinal axis LA.

The seals 906, 908 containment of the lubrication within the annular lubrication track 975 radially forms a second portion 1004 of the lubrication path 1000 about a second lubrication axis SLA, as best illustrated in FIGS. 13 and 16. It should be appreciated that as the lubrication cup 504 is depressed in the direction of force F in FIG. 10, the lubrication advances from the cavity 940 along the first portion 1002 of the lubrication path to the second portion 1004 of the lubrication path around and within the perimeter of the central lubrication path 963 and circular lubrication passage channel 964.

Positioned within the central throughbore 312 is the gear train 602 that includes the pinion gear coupled to the pinion shaft 970. The pinion shaft 970 is rotatably disposed within the bushing 610. The bushing 610 comprises an elongated slot 972 that includes a through opening 973 that passes to the pinion shaft 970. When assembled, the slot 972 and a through bushing opening 973 align under lubrication aperture 974 of the central lubrication path 963.

The central lubrication path 963 and passage channel 964 collectively form the annular lubrication track 975 when the annular support 504 is disposed over the boss 350. The passage of the lubrication from the annular lubrication track 975 through the lubrication aperture 974 into the slot 972 and bushing opening 973 to form a third portion 1006 of the lubrication path 1000, as best illustrated in FIG. 11. Passage of the lubrication from the slot 972 into the bushing opening 973 provides lubrication to the pinion shaft 970 as it rotates within the bushing 610. It should be appreciated that as the lubrication cup 504 is depressed in the direction of force F in FIG. 10, the lubrication advances from the cavity 940 along the first portion 1002 of the lubrication path to the second portion 1004 of the lubrication path and into the third portion of the lubrication path 1006.

A fourth portion 1008 of the lubrication path 1000 is formed by the passage of a portion of the lubrication along the slot 972 toward and onto the pinion gear head 606. Such passage advantageously provides lubrication to both the gear head 606 and gear teeth 382. It should be appreciated that as the lubrication cup 504 is depressed in the direction of force F in FIG. 10, the lubrication advances from the cavity 940 along the first portion 1002 of the lubrication path to the second portion 1004 of the lubrication path and into the third and fourth portions of the lubrication path, 1006 and 1008, respectively. In one example embodiment, the lubrication cup 502 and cavity 940 therein has at least three times the lubrication volume as the volume of lubrication in the sum total of the first through the fourth lubrication portions paths 1002, 1004, 1006, and 1008.

During operation, the moveable lubrication assembly 900 can advantageously be rotated about the boss 350 relative to the handle assembly 200 to accommodate any desired location personalized by the operator during use without the need for tools. As illustrated in FIG. 9A, the lubrication assembly can be rotated endlessly counter-clockwise in the direction of R1 or rotated endlessly clockwise in the direction of R2. The annular support 504 rotates about the boss 350 without interruption to lubrication paths 1002, 1004, 1006, and 1008. In another example embodiment, the lubrication assembly 900 and thumb support endlessly rotate around the boss 350 in either a clockwise or counter-clockwise direction. As the rotation of the moveable lubrication assembly 900 occurs, the lubrication is retained in the annular lubrication track 975, for selective advancement by the user.

Illustrated in FIG. 9B is an exploded view of the gear train 602, and more specifically, the lubrication path 1000 as it passes from the chamber 926 of the cup arrangement indicated by reference character “C” to the pinion gear 604, through portions 1002, 1004, 1006, and 1008. As can be appreciated by the exploded view of FIG. 9B, the second portion 1008 of the lubrication path 1000 provides lubrication to both the pinion shaft 970 within the bushing 610 and to the gear head 604.

As used herein, terms of orientation include upper, lower, inward, outward, etc., figures or drawings. Such orientation terms are not intended to limit the scope of the present disclosure or the claims appended hereto.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A power operated rotary knife having an annular rotary blade, the rotary knife comprising:
a head assembly extending from a handle assembly, the head assembly for rotatably supporting an annular rotary blade;
a drive mechanism disposed within the head assembly comprising a pinion gear and a pinion shaft rotatably disposed within a bushing, the drive mechanism being operatively coupled to said annular rotary blade, rotating said annular blade during use;
a movable lubrication assembly supported along a frame body between said handle assembly and said annular rotary blade, the rotatable lubrication assembly being rotatably disposed about a longitudinal axis of said handle assembly and providing a lubrication path extending from a lubrication adapter to said pinion gear.

2. The power operated rotary knife of claim 1, wherein said movable lubrication assembly further comprises a chamber for holding lubrication to be provided along said lubrication path.

3. The power operated rotary knife of claim 1, wherein said moveable lubrication assembly further comprises an annular support rotatably connected to said frame assembly, said annular support having an annular lubrication track, forming a portion of the lubrication path as lubrication passes from said lubrication adapter to said pinion gear.

4. The power operated rotary knife of claim 3, wherein said annular lubrication track is formed by first and second exterior grooves in said frame assembly and first and second interior grooves in said annular support, said annular track further formed by first and second seals disposed within said grooves.

5. The power operated rotary knife of claim 2, wherein said moveable lubrication assembly further comprises an annular support rotatably connected to said frame assembly, said annular support having an annular lubrication track, forming a portion of the lubrication path as lubrication passes from said lubrication adapter to said pinion gear.

6. The power operated rotary knife of claim 5, wherein said annular lubrication track is formed by first and second exterior grooves in said frame assembly and first and second interior grooves in said annular support, said annular track further formed by first and second seals disposed within said grooves.

7. The power operated rotary knife of claim 6, wherein said a chamber forms a first portion of said lubrication path to said annular lubrication track.

8. The power operated rotary knife of claim 1, wherein said lubrication path further comprises an elongated slot and opening within said bushing to allow for passage of lubrication to said pinion shaft and pinion gear.

9. A method of providing lubrication to a power operated rotary knife comprising the steps of:
extending a head assembly from a handle assembly, the head assembly for rotatably supporting an annular rotary blade; rotating said annular rotary blade with a drive mechanism comprising a pinion gear and pinion shaft; and
lubricating the drive mechanism by providing a moveable lubrication assembly supported along a frame body between said handle assembly and said annular rotary blade.

10. The method of claim 9 further comprising the step of providing a lubrication path from a lubrication adapter located on the moveable lubrication assembly to said pinion gear.

11. The method of claim 10 further comprising the step of allowing said moveable lubrication assembly to rotate about said frame assembly by providing an annular support comprising a portion of said lubricated path.

12. The method of claim 11 further comprising the step of forming said lubrication path in an annular support by locating said path within said support assembly between first and second seals.

13. A power operated rotary knife comprising:
a head assembly extending from a handle assembly, the head assembly for rotatably supporting an annular rotary blade;
a drive mechanism being operatively engaged to said annular rotary blade; and
a moveable lubrication assembly freely rotatable about said handle assembly and said head assembly, the moveable lubrication assembly providing as needed during use lubrication to said drive mechanism independent of location.

14. The power operated rotary knife of claim 13 wherein said moveable lubrication assembly is rotatably located between said head assembly and handle assembly, allowing rotation in both clockwise and counter clockwise direction about a longitudinal axis of said handle assembly.

15. The power operated rotary knife of claim 14 wherein said moveable lubrication assembly provides lubrication to said drive mechanism along a lubrication path.

16. The power operated rotary knife of claim 15 wherein said lubrication path comprises first and second lubrication path transversely connected within a portion of the moveable lubricated assembly.

17. The power operated rotary knife of claim 16 wherein said lubrication path being substantially linear first portion connected to a substantially annular second portion.

18. The power operated rotary knife of claim 17 wherein said second lubrication path comprises a third portion formed by a slot within said drive mechanism.

19. The power operated rotary knife of claim 18 wherein said second lubrication path further comprises a fourth portion for providing lubrication to a pinion shaft and a pinion gear for driving said annular rotary blade.
